(19) United States
(12) Patent Application Publication
(10) Pub. No.: US 2025/0148288 A1
(43) Pub. Date: May 8, 2025

(54) UNSUPERVISED TRAINING METHOD FOR DETECTING REPEATING PATTERNS

(71) Applicant: COMMISSARIAT A L’ENERGIE ATOMIQUE ET AUX ENERGIES ALTERNATIVES, PARIS (FR)

(72) Inventors: Zakaria CHIHANI, Gif Sur Yvette (FR); Romain XU-DARME, Gif Sur Yvette (FR)

(21) Appl. No.: 18/835,701

(22) PCT Filed: Feb. 1, 2023
(86) PCT No.: PCT/EP2023/052419

§ 371 Date: Aug. 2, 2024

(30) Foreign Application Priority Data
Feb. 8, 2022 (FR) 2201090

(51) Int. Cl. G06N 3/088; G06N 3/04

(52) U.S. Cl. CPC G06N 3/088; G06N 3/04

(57) ABSTRACT

A method, implemented by computer, is provided for unsupervised training of a model for detecting repeating patterns in a dataset, the model being composed of a detection layer including at least: a detector of repeating patterns configured to receive a set of pertinent features extracted from the data and supply as output an activation map composed of a set of activation scores, an activation layer consisting at least in normalizing the activation maps, the learning of each detector being limited to the observance of a locality criterion consisting in maximizing a region of the activation map.

### CROSS-REFERENCE TO RELATED APPLICATIONS

This application is a National Stage of International patent application PCT/EP2023/052419, filed on Feb. 1, 2023, which claims priority to foreign French patent application No. FR 2201090, filed on Feb. 8, 2022, the disclosures of which are incorporated by reference in their entireties.

### FIELD OF THE INVENTION

The invention relates to the technical field of the unsupervised automatic learning methods for detecting repeating patterns, notably connected patterns in a data sequence.

### BACKGROUND

For example, the invention relates to the detection of parts of objects in a sequence of images but applies also to other detection or recognition fields, for example in the audio or command control field. In particular, the invention applies for example for detecting different voice types in an audio recording.

The invention falls within the field of the artificial intelligence methods, and more specifically the unsupervised automatic detection methods.

With the development of the deep machine learning, or “deep learning”, techniques, in recent years, convolutional neural networks (CNN) have rapidly become the backbone of many recognition systems, notably the visual recognition systems. The convolutional neural networks are tools that are very effective in the field of object recognition, but they manipulate abstract representations of the image, also called “features”, which cannot necessarily be interpreted to explain the decisional process of the network. The often uninterpretable nature of the decisional algorithms using convolutional neural networks is at the core of the international considerations, with, at the European Parliament level, strong demands for more transparency. At the visual recognition systems level, one of the tracks explored consists in detecting semantic parts of the objects to be recognized and in using these parts in an explicable process culminating in the final decision (e.g. the system detects a pedestrian because it has previously detected a head, arms, legs). These semantic parts represent patterns that are more “simple” to detect than the overall object of which they form part, and correspond to repeating patterns in the learning set.

The machine learning techniques are generally divided into two classes: the supervised methods which necessitate annotating the training data, and the unsupervised methods which process non-annotated data.

The supervised machine learning methods present the drawback of necessitating an annotation of the data in order to supply truth values during the training, which represents a task that is costly and complex to set up. It often necessitates calling on experts to annotate the training data. Moreover, the accuracy of the annotations has a direct impact on the training of the supervised learning models. Thus, in order to reduce the costs of such a task, it is sometimes possible to involve collaborative working platforms (“crowdsourcing”), the contributors of which are not necessarily experts in the field, leading to a loss in quality of the annotations and degrading the training performance levels.

There is therefore a need for a method for detecting repeating patterns that is unsupervised making it possible to both provide an automatic pre-annotation tool (an expert in which could more rapidly verify the results) but also constituting a prerequisite to explicable recognition systems.

The detection of repeating patterns or parts of objects in an image or more generally in a dataset is a problem which has been massively discussed in the literature in recent years, in particular for computer-assisted vision applications involving fine recognition tasks.

There are primarily three categories of automatic learning methods for the detection of parts of objects or repeating patterns: supervised methods, semi-supervised methods or unsupervised methods.

The supervised methods present the drawback of necessitating an annotated training database, the annotation operation being costly to perform as explained above. Moreover, since the necessary quantity of training data is generally very great, there is often a trade-off between the cost and the quality of the annotations.

The semi-supervised methods do not necessitate annotating the training data but nevertheless require information on the category of the objects to be detected, for example a particular species of bird in the case where the object to be detected relates to birds. In this case, the pattern detectors constitute intermediate products of the system and are optimized only in order to perform the final task (e.g. a classification task). Moreover, these methods do not offer any guarantee of coverage of the object because only the parts that are “interesting” for the final task are detected.

In the field of the unsupervised learning methods applied to the detection of parts of objects in images, each image is generally first of all encoded into a set of “features”. Thus, the objective of searching for the parts of objects in the visual space is transformed into an objective of searching for repeating patterns within the domain of the encoded features, this space being very likely more robust than the geometric transformations.

The earliest unsupervised learning methods used image descriptors based on histograms encoding the color or the gradient (i.e. protruding elements such as outlines) to extract pertinent features of the image and then applied a partitioning algorithm, for example of the K means or Support Vector Machines (SVM) type. More recently, unsupervised detection methods based on features extracted from deep convolutional neural networks, or “deep CNN”, have been proposed.

Generally, the methods of the prior art do not make it possible to evaluate the performance of the detectors of patterns or parts of objects independently. On the contrary, the performance of the algorithms is evaluated globally as a gain in accuracy on the final classification task. One drawback with these methods is that they are strongly dependent on the type of processing architecture chosen for the implementation of the decision process.

For example, the scientific publication “Heliang Zheng, Jianlong Fu, Tao Mei, and Jiebo Luo. Learning Multi-attention Convolutional Neural Network for Fine-Grained Image Recognition. In 2017 IEEE International Conference on Computer Vision (ICCV), pages 5219-5227, Venice, October 2017. IEEE. 1, 2, 4” gives an example of unsupervised learning method for the detection of parts of objects. The method described in this reference uses a convolutional neural network complemented by a layer of convolutional filters to produce the detectors. However, while these detectors are initially trained unsupervised, as mentioned by the authors, the method nevertheless necessitates knowing the class of the objects to be detected in order to produce a refining of the parameters of the detectors after the training. It does not therefore consist of a truly unsupervised method.

### SUMMARY OF THE INVENTION

The invention proposes a novel unsupervised learning method which does not necessitate any prior annotation of the data, or any information on the categories of objects to be detected.

The invention makes it possible to construct detectors of parts of objects as weighted sums of activation maps by exploiting the features of a pre-trained deep convolutional neural network. Indeed, most of the current visual recognition systems use neural networks which are pre-trained on classification tasks using millions of training images, and which are the fruit of a decade of optimization by the scientific community. Although initially dedicated to a specific classification task, the first layers of these networks can however be used in order to extract pertinent features from the image. The detectors are trained globally on all of the learning images and not locally (on the scale of a single image) like certain methods of the prior art (Jian Zhang, Runsheng Zhang, Yaping Huang, and Qi Zou. Unsupervised Part Mining for Fine-grained Image Classification. [preprint] ArXiv, abs/1902.09941, 2019) which require an additional phase of semantic alignment.

The invention is based on cost functions, which are defined in order to ensure certain properties of locality, of uniqueness or of grouping specific to the detection of connected parts of objects.

The invention does not necessitate any additional setting based on the knowledge of the classes to be detected or of the categories of objects targeted. The invention does not necessitate modifying the parameters of the pre-trained network used for the extraction of the features from the image, which makes it possible to obtain a rapid convergence during the training of the detectors and to couple the invention with different pre-trained artificial intelligence models capable of providing pertinent features extracted from the data in a “black box” approach.

In particular, the grouping criterion makes it possible to limit the detection of parts of objects that are not adjacent to one another which avoids having to use an additional manual filtering.

The invention also makes it possible to provide a measurement of confidence associated with the decision and based on the distribution of the correlation scores over all of the training data.

This measurement notably makes it possible to detect the visibility of a part of an object.

The subject of the invention is a method, implemented by computer, for unsupervised training of a model for detecting repeating patterns in a dataset, the model being composed of a detection layer comprising at least:
a detector of repeating patterns configured to receive a set of features extracted from the data and supply as output an activation map composed of a set of activation scores, an activation score being characteristic of the absence or the presence of a pattern detected in the data by the detector.
An activation layer consisting at least in normalizing the activation maps,
the learning of the parameters of each detector being limited to the observance of a locality criterion, by means of the optimization of a first cost function Lₗ(K) consisting in maximizing a region of the activation map.

In a variant embodiment, the method according to the invention further comprises the application, to each activation map at the output of the activation layer, of a uniform filter of a dimension dependent on that of said region of the activation map.

According to a variant embodiment, the detection layer comprises several detectors of repeating patterns and the learning of the parameters of each detector is further limited to the observance of a uniqueness criterion, by means of the optimization of a second cost function Lᵤ(K) consisting in avoiding the simultaneous activation of several detectors at a same point of the activation map.

According to a variant embodiment, the uniqueness criterion is implemented by limiting, in the optimization of the second cost function Lᵤ(K), the maximum value of the sum at each point of the activation maps over all of the detectors to a first predefined maximum threshold.

According to a variant embodiment, the detection layer comprises several detectors of repeating patterns and the learning of the parameters of each detector is further limited to the observance of a grouping criterion, by means of the optimization of a third cost function Lₚ(K), consisting in favoring the activation of said detectors on zones of the activation map that are contiguous.

According to a variant embodiment, the grouping criterion is implemented by applying, in the optimization of the third cost function Lₚ(K), a convolutional filter to the sum of the activation maps at the output of the activation layer and by limiting the maximum value of the filtering result to a second predefined maximum threshold.

According to a variant embodiment, the activation layer implements a normalization function, for example the Softmax function.

According to a variant embodiment, the set of features is obtained by means of a model pre-trained on a training dataset.

According to a variant embodiment, the method according to the invention further comprises, at the end of the training, for each detector, an estimation of the distribution of the maximum values of the outputs of the detector and the setting of a confidence threshold dependent on the function of aggregate distribution of said distribution.

Another subject of the invention is a method, implemented by computer, for detecting repeating patterns in a dataset comprising the implementation of a detection model obtained by the method according to the invention.

According to a variant embodiment, the method for detecting repeating patterns according to the invention further comprises, for each detector of repeating patterns and for each new dataset received, the determination of a confidence score dependent on said aggregate distribution function learned in the training applied to said dataset.

According to a variant embodiment, the method for detecting repeating patterns according to the invention further comprises, for each detector of repeating patterns, the application of a filter to the output values of the detector which are below the confidence threshold determined in the training.

According to a variant embodiment, the method for detecting repeating patterns according to the invention further comprises a step of conversion of the activation map produced at the output of the activation layer of the detection model into a map of location of the repeating patterns.

According to a variant embodiment, the data are of image type and the features extracted from the data are organized in a third order tensor.

According to a variant embodiment, the repeating patterns to be detected are parts of objects connected in the images.

Also a subject of the invention is a computer program comprising code instructions for the implementation of the invention and a computer-readable storage medium on which the computer program according to the invention is stored.

### BRIEF DESCRIPTION OF THE DRAWINGS

Other features and advantages of the present invention will become more apparent on reading the following description in relation to the following attached drawings.

FIG. 1 represents a diagram illustrating a method, according to the invention, for unsupervised training of a learning model configured for the detection of repeating patterns, for example of the parts of objects in an image sequence,

FIG. 2 represents a flow diagram of a variant embodiment of the invention allowing the determination of a confidence score for each detection,

FIG. 3 represents several examples of histograms determined at the end of a training of the model to determine the confidence score,

FIG. 4 illustrates the calculation of the visibility threshold of a detector of patterns according to an embodiment of the invention,

FIG. 5 represents an example of results obtained using the automatic detection model trained by means of the method according to the invention.

### DETAILED DESCRIPTION

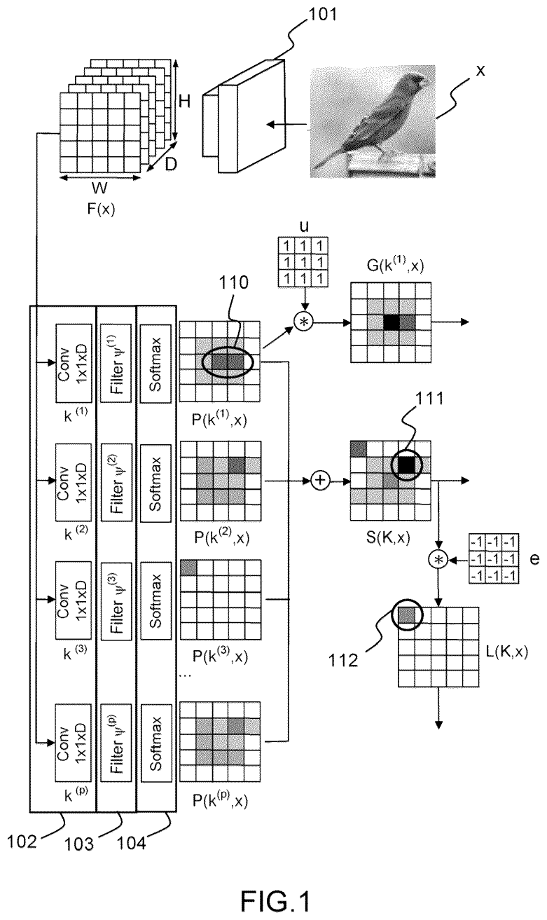

FIG. 1 schematically represents an embodiment of a method for unsupervised training of detectors of patterns according to the invention.

In the example of FIG. 1, the data processed are sequences of images and the objective of the task to be learned n relates to the detection of parts of objects, for example the parts of the body of an animal (head, paws, wings, et cetera). Without departing from the framework of the invention, the data can be of other types (2D, 3D images, derived from perception sensors of different types, audio, text, multimedia, radar, and other such data). Generally, the objective of the method is to detect repeating patterns, more particularly connected patterns, in the data sequence for a category of objects.

The training method of FIG. 1 is described for the processing of an image but the training necessitates a set of several images.

In the example of FIG. 1, the method therefore receives as input an image x in two dimensions. This image is supplied as input for a features extracting system, for example a convolutional neural network 101, producing a set of features representative of the input x. In order to limit the overall complexity of the training, it is possible to use neural networks that are already pre-trained, in which case it is sufficient to remove a certain number of end layers from the network (layers that are generally specific to the task for which this network has been trained) in order to obtain the features of the image.

The function of the convolutional neural network 101 is to extract pertinent features or abstract representations that make it possible to characterize the important information contained in the image.

Thus, the neural network 101 supplies as output a third order tensor F(x), with dimensions of H rows and W columns, each coordinate of which corresponds to a vector of dimension D containing the features extracted from a region of the image. The dimensions H, W of the tensor are generally smaller than the dimensions of the input image x since, in the course of the layers of the convolutional neural network, the size of the output maps is reduced, although the number of channels (dimension D) increases.

Hereinbelow, the indices h, w designate the coordinates of a point or of a vector in a map of dimension H, W or a tensor of dimension H,W,D.

The convolutional neural network 101 can be replaced by any other machine learning algorithm suitable for extracting pertinent features from the input data.

The convolutional neural network 101 is complemented by a detection layer 102 comprising at least one detector of repeating patterns in features extracted from the input data. In the example of FIG. 1, a number p of detectors k⁽¹⁾, . . . k^{(p)} is represented, each detector is implemented by means of a convolution filter of length D equal to the dimension of a vector of features, D being a strictly positive integer number.

One objective of the training of the detection model according to the invention is to learn the coefficients of the detector filters k⁽¹⁾, . . . k^{(p)} such that each detector is configured to detect a part of an object.

An activation layer 104 is added at the output of the detection layer 102 in order to generate, for each detector, an activation map of dimensions W by H. In FIG. 1, the activation maps obtained by the detector k⁽ⁱ⁾ applied to the image x are denoted P(k⁽ⁱ⁾,x). A point of an activation map has for its coordinates h and w, two integers lying respectively between 0 and H−1 and between 0 and W−1.

The activation layer 104 consists in applying an activation function followed by a normalization function.

For example, the activation function Act( ) is a linear rectification function ReLU or a function derived from this first function like “Leaky ReLU” or a parametric linear rectification function.

The normalization function Norm( ) can be the Softmax function or the “Softmax with temperature scale” function or the min-max function.

One advantage in the use of these normalization functions is that it aims to normalize the values of the activation map between 0 and 1, such that the sum of the values of the map is equal to 1, the value 1 corresponding to the definite presence of a pattern to be detected.

The coefficients of the detectors are, for example, initialized with random values at the start of the training.

An additional filtering layer 103 is inserted between the activation function and the normalization function in order to filter values that have an excessively low confidence score. This filtering layer will be explained hereinbelow. During the training of the model, the filters of the layer 103 are initialized the same.

One advantage in the implementation of the invention associated with a pre-trained network 101 lies in the small number of parameters to be learned in the training. Indeed, the number of parameters is equal to D×p with D typically lying between 512 and 2048 and p for example of the order of ten or so detectors. By comparison, the pre-trained network generally contains several tens of millions of parameters.

The learning of the repeating pattern detection functions k⁽¹⁾, . . . k^{(p)} is done subject to one or more constraints out of the following constraints.

A first so-called locality constraint consists in ensuring that each detector is capable of detecting, for each training image, a pattern in a predefined number of regions of attention of the image.

In other words, the locality criterion aims to ensure that each detector is focused consistently on at least one region of attention of the image, that is to say that each detector must be focused, throughout the training, on the same regions of the image.

A second so-called uniqueness constraint consists in dictating that each of the detectors be focused on a different region of attention of the image. In other words, several detectors must not be dedicated to the same region of attention, and therefore not to the same repeating pattern.

A third so-called grouping constraint consists in taking into account the connected aspect of the objects of which parts are wanted to be detected. Thus, the regions of attention associated with each detector must be contiguous so as to correspond to a connected pattern.

Each of the above-mentioned constraints is taken into account alone or in combination with one or more others to determine a cost function to be minimized by a gradient descent algorithm, the aim of which is to update the coefficients of the detection functions in the course of the training over several images.

The learning of the set of the detection functions k⁽ⁱ⁾ so as to implement the first locality constraint can be translated as a problem of optimization of the following cost function:

$${L}_{l} ( K ) = \frac{- 1}{p} {\sum }_{i = 1}^{p} \frac{1}{n} {\sum }_{x ∈ {X}_{ent}} {max}_{h , w} ( {P ( {k}^{( i )} , x )}_{[ h , w ]} ) \qquad ( 1 )$$

In other words, the locality constraint is translated by the minimization of the cost function (1) so as to search for the detector parameters which make it possible to obtain a maximization, as an average over all the detectors, of a point of the activation map of coordinates [h,w], for all of the n images of a training base Xₑₙₜ.

In a variant embodiment, the locality constraint is relaxed by applying to the activation map a uniform filter whose dimension defines a sub-region of the map. For example, the uniform filter u has a 3×3 dimension, and a filtered activation map is then obtained:

$$G ( {k}^{( i )} , x ) = P ( {k}^{( i )} , x ) * ( \begin{matrix}1 & 1 & 1 \\ 1 & 1 & 1 \\ 1 & 1 & 1\end{matrix} ) \qquad ( 2 )$$

The operator * is the convolution operator.

The cost function to be minimized then becomes

$${L}_{l} ( K ) = \frac{- 1}{p} {\sum }_{i = 1}^{p} \frac{1}{n} {\sum }_{x ∈ {X}_{ent}} {max}_{h , w} ( {G ( {k}^{( i )} , x )}_{[ h , w ]} ) \qquad ( 3 )$$

This variant offers the advantage of allowing activations in a vicinity (here of 3×3 dimension) of parameterized size instead of a single point of the activation map. That avoids having the detectors be focused on discriminating details situated between two vectors of adjacent features which represent one and the same part of the object.

In FIG. 1, in the activation map P(k⁽¹⁾,x) of the first detector, an activation zone 110 with two adjacent points having the same maximum value has been represented. After application of the uniform filter u, each point of the filtered activation map G (k⁽¹⁾,x) corresponds to a zone of a dimension equal to the dimension of the uniform filter in the activation map P(k⁽¹⁾,x).

The cost function of the equation (3) does not make it possible to avoid having the system learn only a part of the patterns to be detected, the ones that are most simple to be visually detected, with several detectors learning the same pattern. In order to avoid this scenario, in a variant embodiment, the second uniqueness constraint is implemented by ensuring that each vector of features F(x) is not simultaneously highly correlated with several convolution filters k⁽ⁱ⁾.

For that, the sum of the activation maps is calculated via the equation (4):

$${S}_{[ h , w ]} ( K , x ) = {\sum }_{i = 1}^{p} {P ( {k}^{( i )} , x )}_{[ h , w ]} \qquad ( 4 )$$

The uniqueness constraint of each part of object detected by a detector is implemented by ensuring that no position (h,w) of the activation map contains an activation value above a predetermined uniqueness threshold tᵤ. This constraint is translated by the minimization of the following cost function:

$${ℒ}_{u} ( K ) = \frac{1}{n} {\sum }_{x ∈ {X}_{ent}} max ( {max}_{h , w} ( {S}_{[ h , w ]} ( K , x ) - {t}_{u} , 0 ) ) \qquad ( 5 )$$

The function Lᵤ(K) is zero if all the values of S_{[h,w]}(K,x) are below the threshold tᵤ for all the training images and it is strictly positive otherwise.

The uniqueness constraint aims to avoid the appearance of a very high value (above the threshold tᵤ) for a point of the sum of the activation maps. The value of the threshold tᵤ is preferably equal to 1. Thus, having the sum of the activation values of the different detectors at a same point be greater than the maximum activation value which is 1 is prevented because of the normalization by the normalization function. Thus, a total overlap between the activations of two distinct detectors is prohibited.

The benefit of an additive constraint based on the activation map aggregated over all of the detectors, rather than a multiplicative constraint as described in the publication “Heliang Zheng, Jianlong Fu, Tao Mei, and Jiebo Luo. Learning Multi-attention Convolutional Neural Network for Fine-Grained Image Recognition. In 2017 IEEE International Conference on Computer Vision (ICCV), pages 5219-5227, Venice, October 2017. IEEE. 1, 2, 4”, is that that makes it possible to allow a partial overlap of several parts.

In FIG. 1, the aggregate activation map S(K,x) is represented with a point 111 which exceeds the threshold tᵤ and corresponding to a quasi-total overlap of the main zones of attention of the detectors k⁽²⁾ and k^{(p)}. The uniqueness constraint makes it possible to avoid the presence of such total overlaps.

In a variant embodiment, a third grouping constraint is implemented. The aggregate activation map S(K,x) can be seen as a mask of segmentation of an object situated in the image. It is assumed that the objects of the category of the training data are connected, that is to say that they are formed of a single piece. With this assumption, it is possible to penalize, in the learning, the isolated activations.

This constraint can be implemented by applying to the aggregate activation map S(K,x) a convolutional filter given by the relationship (7)

$$L ( K , x ) = S ( K , x ) * ( \begin{matrix}1 & 1 & 1 \\ 1 & 1 & 1 \\ 1 & 1 & 1\end{matrix} ) \qquad ( 7 )$$

The filtered map L_{h,w}(K,x) makes it possible to measure the difference between the aggregate activation value at the point (h,w) and the sum of the activation values surrounding the point (h,w).

In a way similar to the equation (5), the grouping constraint can be implemented by ensuring that no position (h,w) of the filtered aggregate activation map L_{h,w}(K,x) contains an activation value that is higher than a predetermined grouping threshold tₚ. This constraint is translated by the minimization of the following cost function:

$${ℒ}_{p} ( K ) = \frac{1}{n} {\sum }_{x ∈ {X}_{ent}} max ( {max}_{h , w} ( {L}_{[ h , w ]} ( K , x ) - {t}_{p} , 0 ) ) \qquad ( 8 )$$

Preferably, the threshold tₚ is taken close to 0, for example equal to 0.1.

This grouping constraint aims to avoid activations in zones that are not contiguous while the activation zones of the various detectors should correspond to different parts of a same connected object and should therefore, theoretically, be contiguous.

In the example of FIG. 1, the grouping constraint makes it possible to avoid an activation on the isolated point 112 identified on the filtered map L_{[h,w]}(K,x).

Thus the overall cost function used to train the detection model described in FIG. 1 and to learn the coefficients of the detection functions via a gradient descent algorithm, is given by the relationship (9):

$$L ( K ) = {L}_{l} ( K ) + {λ}_{u} {L}_{u} ( K ) + {λ}_{p} {L}_{p} ( K ) \qquad ( 9 )$$

The parameters λᵤ, λₚ are positive real numbers or zeros which are set so as to control the relative significance of the three constraints: locality, uniqueness and grouping.

The coefficients of the detection functions k⁽ⁱ⁾ are updated by minimizing the cost function of the equation (9) by means of a gradient descent algorithm, iteratively over all of the images of the training base.

At the end of the training, p convolution functions k⁽ⁱ⁾ are obtained which correspond to the detectors that are each capable of detecting a part of a same object belonging to a given class of objects.

A variant embodiment of the invention will now be described which consists in determining a confidence score and an automatic visibility detection filter 103 for each image processed by the detection model trained by the method described previously.

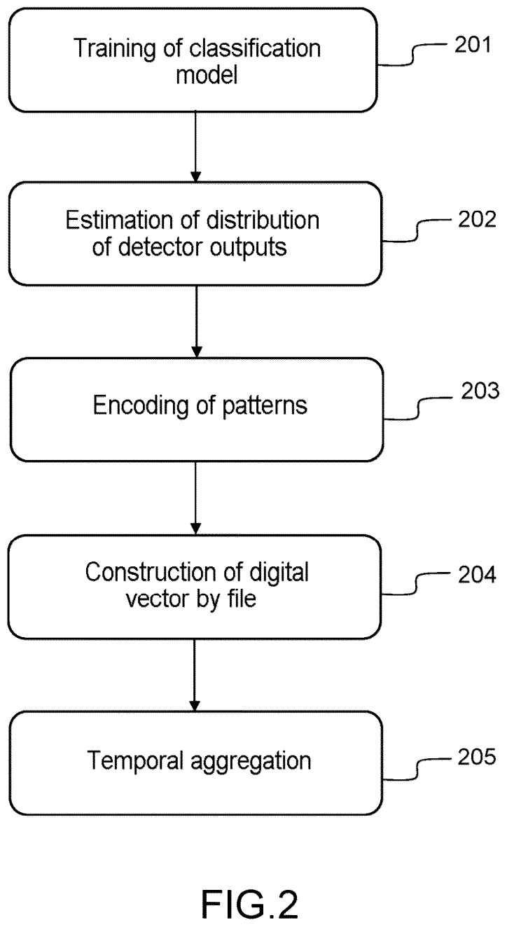

The method for determining a confidence score, according to an embodiment of the invention, is illustrated by the flow diagram of FIG. 2.

The first step 201 of the method consists in performing the complete training of the model as described in FIG. 1 on a training database corresponding to a class of objects (for example a type of animal or a type of vehicle).

In the step 202, all of the training data is passed once again through the model of FIG. 1, without modifying the parameters of the model. In other words, an inference phase of the neural network is executed by propagating the training data from the input of the network to the output. At the output of the detectors k⁽ⁱ⁾ and after application of the activation function, the maximum of the output values is measured for each input image and a histogram of these data is then calculated for each of the detectors. This histogram is then modelled by a normal distribution of mean μᵢ and of variance σᵢ².

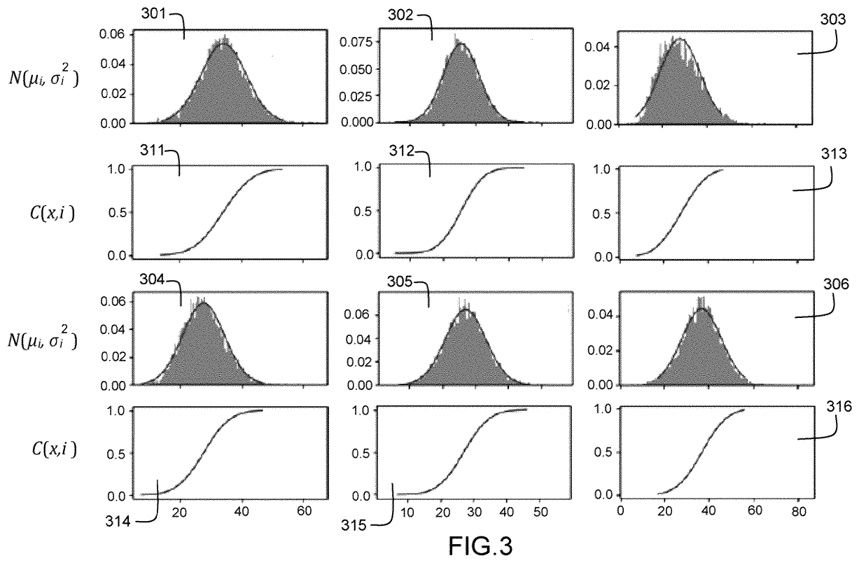

FIG. 3 represents an example of six histograms 301-306 obtained for six detectors trained on a training dataset composed of images of birds. Each detector is trained to detect a part of the body of a bird from among the head/throat (301), the wings/the body (302), the feet (303), the chest (304), the back/the wings (305), the head (306).

The histograms of FIG. 3 are obtained by measuring, on the network already trained, the maximum of the outputs of the activation function Act( ) after detection, in other words, the following function:

$${H}_{i} ( x ) = {max}_{h , w} ( Act ( {F}_{h , w} ( x ) * {k}^{( i )} ) )$$

The histograms obtained correspond to the activation values before application of the normalization function Norm( ).

These distributions can be modelled by laws of probability, for example a law of normal distribution [symbol] (μᵢ,σᵢ²) of mean μᵢ and of variance σᵢ² the parameters of which are determined in the step 203 from the histograms 301-306.

In the step 204, a confidence measurement C(x,i) is determined by calculating the aggregate distribution function associated with the law of probability modelling the distribution of the values of Hᵢ(x). In the case of a modelling by a normal law [symbol] (μᵢ,σᵢ²), the following is obtained:

$$C ( x , i ) = Φ ( {H}_{i} ( x ) , {μ}_{i} , {σ}_{i}^{2} ) .$$

Without departing from the framework of the invention, the law of probability used can also be an asymmetrical normal law modelled by three parameters (position, scale and form). One advantage is that that makes it possible to adapt the modelling to asymmetrical distributions. In this case, the confidence measurement Φ depends on three parameters of the model and no longer on two.

The confidence measurement is represented in FIG. 3 for each of the detectors for the curves 311 to 316. It corresponds to a sigmoid function with values between 0 and 1.

The confidence measurement makes it possible to estimate a level of confidence in the part of object which is detected by a detector. In particular, this measurement makes it possible to signal that a detector has been activated for an object or a part of object which may not be visible on the scene, because it is partially hidden, or even for an object which does not correspond to the class of objects for which the network has been trained (for example images of cars supplied as input to a network trained to recognize images of birds).

For that, in the step 205, the first thing to be determined, for each detector, is the minimum correlation score sᵢ such that Φ(sᵢ,μᵢ,σᵢ²)=t_{ν}⁽ⁱ⁾ with t_{ν}⁽ⁱ⁾ visibility threshold lying between 0 and 1. The visibility threshold is set independently for each detector, for example, as a function of an a priori knowledge concerning certain parts of objects to be detected. For example, in the case of images of birds, if the head of the bird is considered to be always present in the image, the visibility threshold must be set to a value close to 0.

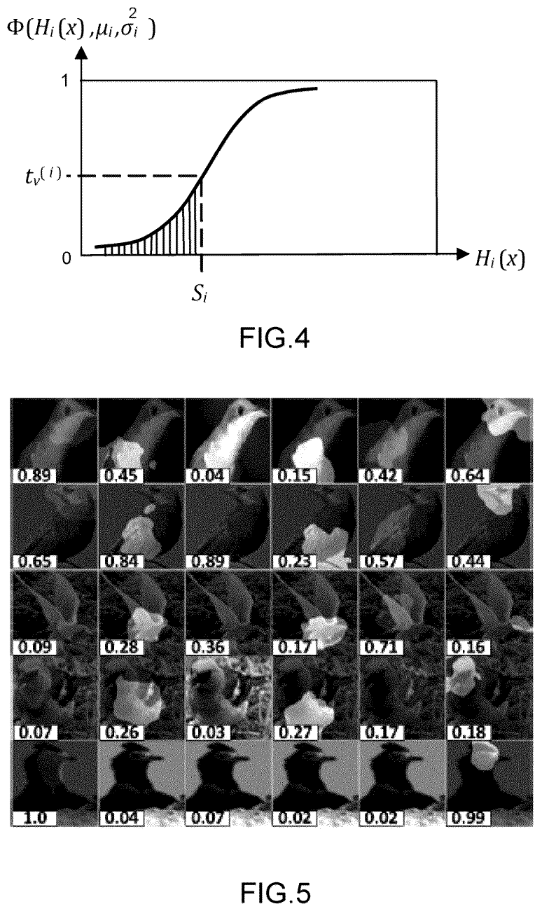

FIG. 4 represents an example of confidence measurement function Φ(Hᵢ(x),μᵢ,σᵢ²) with a visibility threshold t_{ν}⁽ⁱ⁾. The values below the visibility threshold t_{ν}⁽ⁱ⁾ correspond to parts of objects that are not visible.

Once the training is done and the visibility threshold is set for each detector, the model of automatic detection of parts of objects, unsupervised, can be used on images representing the same categories of objects.

The visibility threshold determined at the end of the training is used during execution to filter the activations as a function of the maximum value at the output of the activation function, in other words Hᵢ(x). If Hᵢ(x) is strictly greater than the visibility threshold, it is considered that the part of object i is visible in the image x. Otherwise, the activation is filtered (set to 0) by considering that the part of object i is not visible because it is partially masked or because the object does not correspond to the class of objects for which the network has been trained.

Thus, a layer of filters 103 can be inserted in the trained model between the output of the activation functions (not represented in FIG. 1) and the inputs of the normalization layer 104. This filter is defined by the following function:

ψ⁽ⁱ⁾(T)=T if max_{h,w}T>sᵢ and [0]^{H×W} otherwise, T being a matrix of values of dimension H by W.

In parallel, the value of the confidence score obtained via the measurement Φ(Hᵢ(x),μᵢ,σᵢ²) can be supplied as output with the detection results in order to add confidence information to the result obtained.

In a particular embodiment of the invention, a visualization step is added which consists in converting the activation map produced at the output of the activation layer 104 into a map of location of the parts of objects in the image. For that, one possible method consists in calculating the pixels of the visualization map by means of the following formula:

$${N}^{( i )} ( x ) = {\sum }_{h , w} {P ( {k}^{( i )} , x )}_{[ h , w ]} * M ( {P ( {k}^{( i )} , x )}_{[ h , w ]} )$$

The function M can designate for example an “Integrated gradients” function as described in the reference “Mukund Sundararajan et al, “Axiomatic attribution for deep networks, Proceedings of the 34th international conference on machine learning, pages 3319-3328, 2017”, or else a smoothed gradients function SmoothGrad, as defined in “Smilkov et al, Smoothgrad: removing noise by adding noise. ArXiv, abs/1706.03825, 2017”.

This method offers the following advantage. Instead of calculating the gradients only at the positions which maximize the activations in the activation maps P(k⁽ⁱ⁾,x)_{[h,w]′} this method makes it possible to include contributions of other positions and to determine more specifically the pixels of the matrix x involved in the part of object detected.

As an option, it is possible to apply to the image obtained N⁽ⁱ⁾(x) a bit mask specific to each detector by applying a Gaussian filter, for example of dimension 5×5 followed by a min-max normalization and a deletion of the values below a predetermined threshold tₘ, for example equal to 0.4.

FIG. 5 represents an example of results obtained using the automatic detection model trained by means of the method according to the invention.

FIG. 5 illustrates the results of detection of parts of objects for images of birds from the database CUB200. Each row corresponding to a different image (five images in all) and each column to a detector focused on a different region of attention (six detectors in all). The regions of attention correspond to the parts of objects of the example of FIG. 3.

For each image, and each detector, the calculated confidence score is indicated. The visibility threshold is set at 0.1. Thus, for the detectors numbered 2 to 5, on the fifth image, no part detection is made because the associated confidence score is too low.

The invention can be implemented as a computer program comprising instructions for its execution. The computer program can be stored on a processor-readable storage medium.

The reference to a computer program which, when it is executed, performs any one of the functions described previously, is not limited to an application program running on a single host computer. On the contrary, the terms computer program and software are used here in a general sense to refer to any type of computing code (for example application software, firmware, a microcode, or any other form of computer instruction) which can be used to program one or more processors to implement aspects of the techniques described here. The computing means or resources can notably be distributed (“Cloud computing”), possibly according to peer-to-peer technologies. The software code can be executed on any appropriate processor (for example a microprocessor) or processor core or a set of processors, whether they be provided in a single computation device or distributed between several computation devices (for example such as devices possibly accessible in the environment of the device). The executable code of each program allowing the programmable device to implement the processes according to the invention can be stored, for example, in the hard disk or in read-only memory. Generally, the program or programs will be able to be loaded into one of the storage means of the device before being executed. The central processing unit can control and direct the execution of the instructions or portions of software code of the program or programs according to the invention, instructions which are stored in the hard disk or in the read-only memory or else in the other above-mentioned storage elements.

The invention can be implemented on a computation device based, for example, on an embedded processor. The processor can be a generic processor, a specific processor, an application-specific integrated circuit (known also by the acronym ASIC) or a field-programmable gate array (known also by the acronym FPGA). The computation device can use one or more dedicated electronic circuits or a general-purpose circuit. The technique of the invention can be performed on a reprogrammable computation machine (a processor or a microcontroller for example) running a program comprising a sequence of instructions, or on a dedicated computation machine (for example a set of logic gates like an FPGA or an ASIC, or any other hardware module).

1. A method, implemented by computer, for unsupervised training of a model for detecting repeating patterns in a dataset of image, audio or command control type, the model being composed of a detection layer comprising at least:
a detector of repeating patterns configured to receive a set of features extracted from the data and supply as output an activation map composed of a set of activation scores, an activation score being characteristic of the absence or the presence of a pattern detected in the data by the detector,
an activation layer consisting at least in normalizing the activation maps,
the learning of the parameters of each detector being limited to the observance of a locality criterion, by means of the optimization of a first cost function Lₗ(K) consisting in maximizing a region of the activation map.

2. The method for unsupervised training of a detection model as claimed in claim 1, further comprising the application, to each activation map at the output of the activation layer, of a uniform filter of a dimension dependent on that of said region of the activation map.

3. The method for unsupervised training of a detection model as claimed in claim 1, wherein the detection layer comprises several detectors of repeating patterns and the learning of the parameters of each detector is further limited to the observance of a uniqueness criterion, by means of the optimization of a second cost function Lᵤ(K) consisting in avoiding the simultaneous activation of several detectors at a same point of the activation map.

4. The method for unsupervised training of a detection model as claimed in claim 3, wherein the uniqueness criterion is implemented by limiting, in the optimization of the second cost function Lᵤ(K), the maximum value of the sum at each point of the activation maps over all of the detectors to a first predefined maximum threshold.

5. The method for unsupervised training of a detection model as claimed in claim 1, wherein the detection layer comprises several detectors of repeating patterns and the learning of the parameters of each detector is further limited to the observance of a grouping criterion, by means of the optimization of a third cost function Lₚ(K) consisting in favoring the activation of said detectors on zones of the activation map that are contiguous.

6. The method for unsupervised training of a detection model as claimed in claim 5, wherein the grouping criterion is implemented by applying, in the optimization of the third cost function Lₚ(K), a convolutional filter to the sum of the activation maps at the output of the activation layer and by limiting the maximum value of the filtering result to a second predefined maximum threshold.

7. The method for unsupervised training of a detection model as claimed in claim 1, wherein the activation layer implements a normalization function, for example the Softmax function.

8. The method for unsupervised training of a detection model as claimed in claim 1, wherein the set of features is obtained by means of a model pre-trained on a training dataset.

9. The method for unsupervised training of a detection model as claimed in claim 1, further comprising, at the end of the training, for each detector, an estimation of the distribution of the maximum values of the outputs of the detector and the setting of a confidence threshold dependent on the function of aggregate distribution of said distribution.

10. A method, implemented by computer, for detecting repeating patterns in a dataset comprising the implementation of a detection model obtained by the method for unsupervised training of a detection model as claimed in claim 1.

11. The method for detecting repeating patterns as claimed in claim 10, further comprising:
at the end of the training, for each detector, an estimation of the distribution of the maximum values of the outputs of the detector and the setting of a confidence threshold dependent on the function of aggregate distribution of said distribution, and
for each detector of repeating patterns and for each new dataset received, the determination of a confidence score dependent on said aggregate distribution function learned in the training applied to said dataset.

12. The method for detecting repeating patterns as claimed in claim 11, further comprising, for each detector of repeating patterns, the application of a filter to the output values of the detector which are below the confidence threshold determined in the training.

13. The method for detecting repeating patterns as claimed in claim 11, further comprising a step of conversion of the activation map produced at the output of the activation layer of the detection model into a map of location of the repeating patterns.

14. The method as claimed in claim 1, wherein the data are of image type and the features extracted from the data are organized in a third order tensor.

15. The method as claimed in claim 14, wherein the repeating patterns to be detected are parts of objects connected in the images.

16. A computer program comprising code instructions for the implementation of the methods as claimed in claim 1, when said program is run on a computer.

17. A computer-readable storage medium on which the computer program as claimed in claim 16 is stored.
